(19) United States
(12) Patent Application Publication
(10) Pub. No.: US 2007/0180042 A1
(43) Pub. Date: Aug. 2, 2007

(54) User configurable automatic voice message prioritization

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/345,928

(22) Filed: Feb. 2, 2006

(51) Int. Cl. G06F 15/16

(52) U.S. Cl. 709/207

(57) ABSTRACT

An apparatus in one example has: a mobile terminal; a voice mail system operatively coupled to a voice mail database, the voice mail database having a plurality of prioritized voice messages for predetermined mobile terminals; and a network operatively coupled to the mobile terminal and the voice mail system. Embodiments according to the present method and apparatus allow the user to assign priorities to various phone numbers. This may be implemented in one embodiment by use of voice prompts to have the user enter a phone number and a priority number. This information is then stored in the network. When the user retrieves the voice messages, the network plays them back according to the priorities associated with the phone numbers that the messages were received on.

### TECHNICAL FIELD

The invention relates generally to teleconununication networks, and more particularly to network support for prioritizing voice messages.

### BACKGROUND

Voice mail is a service provided by a phone network to store and manage voice messages for individual users. Like an answering machine, voice mail can handle a call when the person being called is unavailable, by playing a greeting message and recording a voice message from the caller. From a modern mobile phone, the voice mail system can usually be accessed by pressing and holding the “1” key, although some phones use a different key, or require dialing a code. Once connected to the system, voice messages can be retrieved and managed using a traditional phone menu interface. Some systems can allow a user to have their message placed at the top of the recipient's voicemail queue, so it will be the first waiting message.

Many times a mobile subscriber may receive many voice messages from different callers. Typically, they are retrieved by the subscriber and played according to the time received. With the likelihood of many messages, some important messages (e.g., messages from your child's school) may not get the subscriber's attention until toward the end of the message queue if the messages were only received recently. Also they may not be retrieved at all due to various reasons. As one example, an employee who returns from vacation to confront a voice mailbox containing a large amount of messages and attempts to screen the messages, may become frustrated due to the slow process and just delete all the messages. Without time to review all the messages, the employee may just assume that any important message will be sent again.

Unfortunately, a user has no way of finding and listening to more important messages without reviewing other messages. In particular, recipient must review the voice messages in an order determined by the voice mail system, or according to priorities set by senders of the voice messages.

It is therefore a drawback of the prior art that the recipient cannot set priorities to voice messages.

### SUMMARY

The invention in one implementation encompasses an apparatus. The apparatus in one embodiment may comprise: a mobile terminal; a voice mail system operatively coupled to a voice mail database, the voice mail database having a plurality of prioritized voice messages for predetermined mobile terminals; and a network operatively coupled to the mobile terminal and the voice mail system.

The invention in a further implementation encompasses a method. The method in one embodiment may comprise: provisioning from a mobile terminal a list of priority phone numbers for voice message retrieval; and assigning each phone number of the list of priority phone numbers a selected priority level from a plurality of priority levels.

### DESCRIPTION OF THE DRAWINGS

Features of exemplary implementations of the invention will become apparent from the description, the claims, and the accompanying drawings in which:

FIG. 1 is a representation of one implementation of a telecommunications system which allows a mobile subscriber to provision a list of priority phone numbers for voice message retrieval and to assign each phone number a different priority;

FIG. 2 is a representation of one embodiment of the voice message database according to the present apparatus;

FIG. 3 is a representation of one exemplary flow diagram according to the present method; and

FIG. 4 depicts a very general flow diagram according to embodiments of the present method.

### DETAILED DESCRIPTION

A typical mail access session of a user with a voice mail system over the telephone occurs as follows. After a user calls the voice mail system, user authentication is performed by the user entering a name and password using the dual-tone multi frequency (DTMF) keys on the telephone when prompted to do so by the voice mail system. The voice mail system then provides the user with an option of choosing one of a possible set of actions by pressing DTMF keys on the telephone. The directions provided by the voice mail system to the user to navigate through the menu are called voice prompts. The user understands the prompts and presses the appropriate DTMF keys to access the voice mail messages. Thus, the process of extracting the voice mail messages in a mail access session involves a navigation through the voice prompts of the voice mail system until the voice messages are played back.

Some voice mail systems may also provide access to voice mail over a data network (e.g., a TCP/IP connection over the internet). In this method of access, a client computer interacts with the voice mail system using a set of messages in an agreed upon protocol (e.g., TCP/IP) and sends or receives the voice mail as compressed audio files.

Embodiments according to the present method and apparatus allow the user to assign priorities to various phone numbers. This may be implemented in one embodiment by use of voice prompts to have the user enter a phone number and a priority number. This information is then stored in the network. When the user retrieves the voice messages, the network plays them back according to the priorities associated with the phone numbers that the messages were received on. For example, voice messages corresponding to phone numbers with a highest assigned priority may be played back before voice messages corresponding to phone numbers with a lower assigned priority. The network also allows the user to reassign priorities or remove priorities for phone numbers.

In one methodology according to the present method and apparatus the system provides a mechanism for the mobile subscriber to provision a list of priority phone numbers for voice message retrieval and to assign each phone number a different priority level, e.g. .630-555-1212 priority=1, etc.

Another methodology according to the present method and apparatus is for the system to prioritize/sort the voice messages for the subscriber according to the priority level of the calling party's number if defined by the subscriber. For example, all messages received from the priority #1's phone number will be placed at the beginning of the message queue followed by messages received from the priority #2's phone number. Messages received from the same number may be sorted according to the time arrived.

A further methodology according to the present method and apparatus is for the system to play the messages according to their assigned priorities.

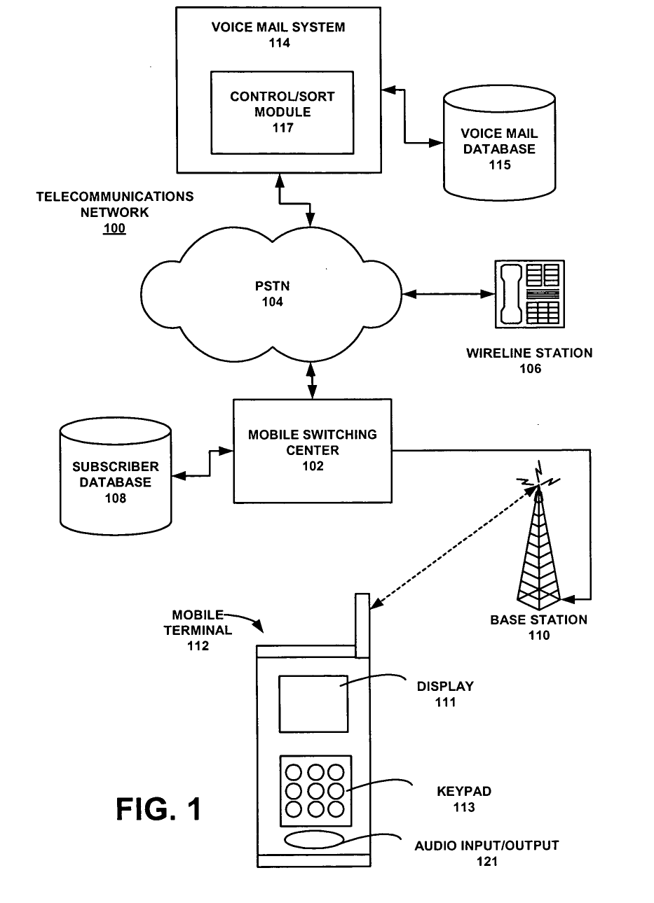

FIG. 1 is a representation of one implementation of a telecommunications system which allows a mobile subscriber to provision a list of priority phone numbers for voice message retrieval and to assign each phone number a different priority level.

In this embodiment a telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be connected to the MSC 102. The PSTN 104 may be operatively coupled to, for example, a wireline station 106. The PSTN 104 may route calls to and from a mobile terminal 112 through the MSC 102. The MSC 102 may also be connected to at least one base station (BS) 110. The base station 110 communicates with the mobile terminal 112 in its service area using a subscriber database 108. The PSTN 104 generally may be implemented as a worldwide voice telephone network accessible to all those with telephones and access privileges (e.g., AT&T long distance network). The mobile terminal 112 may be any one of a number of devices, such as a cell phone, a personal data assistant (PDA), a laptop computer, etc. The mobile terminal 112 may have a display 111, an audio input/output 121, and a text entry part, such as keypad 113. Embodiments of the present method and apparatus may also be utilized with the wireline station 106 or other wired terminals, such as desktop computers.

The PSTN 104 may also be operatively coupled to a voice mail 114 that is operatively coupled to a voice mail database 115. Voice messages for various subscribers may be stored in the voice mail database 115. The voice mail system 114 may have a control/sort module 117, wherein the control/sort module 117 enters into the voice mail database 115 and retrieves voice messages from the voice mail database 115. The voice mail system 114 may also perform the priority sorting of the voice messages to be sent to a respective subscriber.

Other types of networks, such as an ISM network may be used instead of the PSTN. Also, for example, the voice mail system may be considered to be part of the network, or may be a separate entity that is operatively coupled to the network. Voice mail messages may be stored in the network or may be stored in a storage that is operatively coupled to the network.

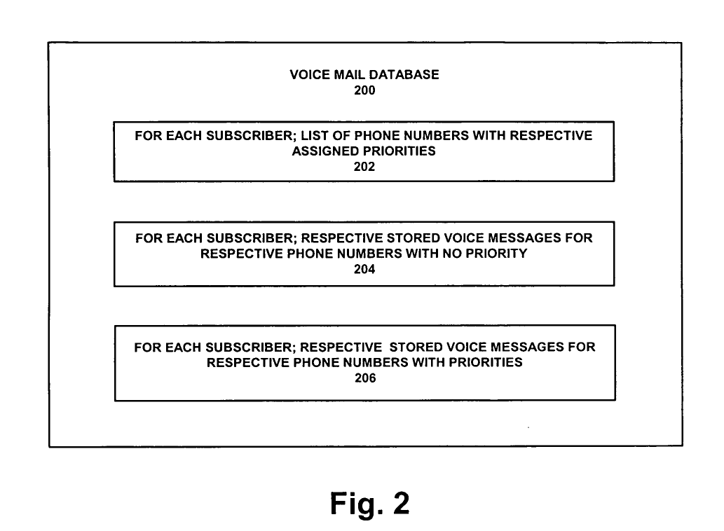

FIG. 2 is a representation of one embodiment of the voice mail database 200. Although many configurations are possible, in this embodiment the voice mail database 200 may have stored therein a plurality of voice messages. The voice mail database 200 may have, for each subscriber, a list 202 of phone numbers with respective assigned priorities, respective stored voice messages 204 for respective phone numbers with no priority, and respective stored voice messages 206 for respective phone numbers with priorities. With this database the voice mail system checks inputs from mobile terminals to determine if they are authorized subscribers to this service. The voice mail system may then provide the voice messages according to the assigned priorities of the respective corresponding phone numbers.

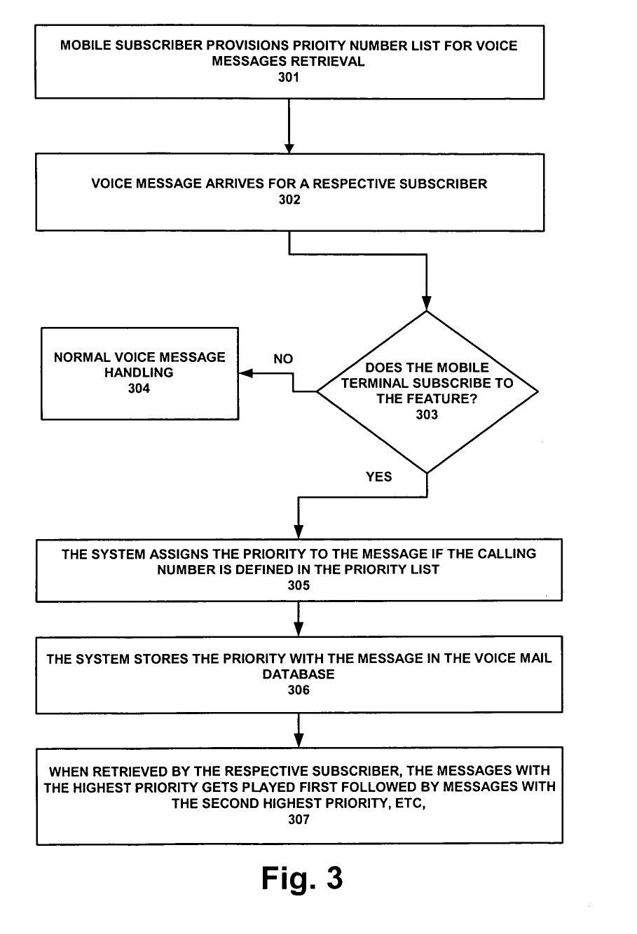

FIG. 3 is a representation of one exemplary flow diagram according to the present method. This embodiment of the present method may have the steps of: mobile subscriber provisions priority number list for voice messages retrieval (301); voice messages arrives for a respective subscriber (302); does the mobile terminal subscribe to the feature? (303); if mobile terminal is not a subscriber, then normal voice message handling is utilized (304); if mobile terminal is a subscriber, then the system assigns the priority to the voice message if the calling number is defined in the priority list (305); the system stores the priority with the message in the voice mail database (306); when retrieved by the respective subscriber, the messages with the highest priority gets played first followed by messages with the second highest priority, etc. (307).

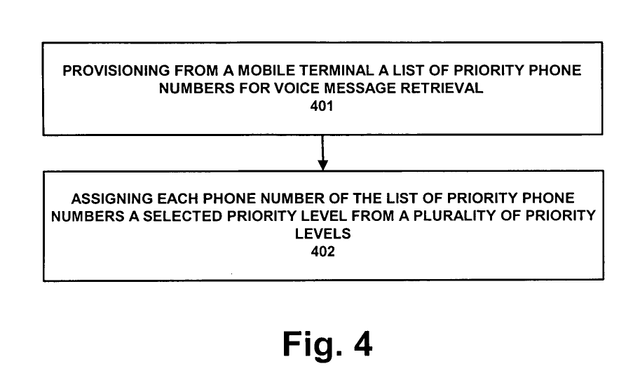

FIG. 4 depicts a very general flow diagram according to embodiments of the present method. This embodiment may have the steps of: provisioning from a mobile terminal a list of priority phone numbers for voice message retrieval (401); and assigning each phone number of the list of priority phone numbers a selected priority level from a plurality of priority levels (402).

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium in one example may comprise one or more of a magnetic, electrical, optical, biological, and atomic data storage medium. For example, the computer-readable signal-bearing medium may comprise-floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method, comprising:
provisioning from a mobile terminal a list of priority phone numbers for voice message retrieval; and
assigning each phone number of the list of priority phone numbers a selected priority level from a plurality of priority levels.

2. The method according to claim 1, wherein the mobile terminal provisions a priority for each phone number in the list of priority phone numbers.

3. The method according to claim 1, wherein the method further comprises determining if a mobile terminal requesting stored voice messages is a subscriber.

4. The method according to claim 3, wherein, if the mobile terminal is not a subscriber, the method further comprises storing voice messages for the mobile terminal in an order corresponding to when the voice messages were received without any priority.

5. The method according to claim 3, wherein, if the mobile terminal is a subscriber, the method further comprises assigning a priority to the voice message if the calling number is defined in the list of priority phone numbers, and storing the voice message.

6. The method according to claim 3, wherein, if the mobile terminal is not a subscriber, the method further comprises supplying stored voice messages to the mobile terminal in an order corresponding to when the voice messages were received without any priorities.

7. The method according to claim 3, wherein, if the mobile terminal is a subscriber, the method further comprises supplying stored voice messages to the mobile terminal in an order corresponding to the priorities assigned to the voice messages for a respective phone number.

8. An apparatus, comprising:
a mobile terminal;
a voice mail system operatively coupled to a voice mail database, the voice mail database having a plurality of prioritized voice messages for predetermined mobile terminals; and
a network operatively coupled to the mobile terminal and the voice mail system.

9. The apparatus according to claim 8, wherein the voice mail system has a control/sort module, and wherein the control/sort module enters voice messages into the voice mail database and retrieves voice messages from the voice mail database according to the priorities.

10. The apparatus according to claim 9, wherein the voice mail system performs priority sorting of the voice messages to be sent to a respective mobile terminal.

11. The apparatus according to claim 8, wherein the voice mail system has a control/sort module, and wherein the control/sort module enters voice messages into the voice mail database and retrieves voice messages from the voice mail database.

12. The apparatus according to claim 11, wherein the voice mail system performs priority sorting of the voice messages to be sent to a respective mobile terminal.

13. The apparatus according to claim 8, wherein, if the mobile terminal is a subscriber, a priority is assigned to the voice message if the calling number is defined in the list of priority phone numbers.

14. The apparatus according to claim 13, wherein the phone numbers and the priorities to be assigned thereto are input from the mobile terminal.

15. The apparatus according to claim 8, wherein, if the mobile terminal is not a subscriber, voice messages are supplied to the mobile terminal in an order corresponding to when the voice messages were received without any priorities.

16. The apparatus according to claim 8, wherein, if the mobile terminal is a subscriber, stored voice messages are supplied to the mobile terminal in an order corresponding to the priorities assigned to the voice messages for a respective phone number.

17. An apparatus, comprising:
means for provisioning from a terminal a list of priority phone numbers for voice message retrieval; and
means for assigning each phone number of the list of priority phone numbers a selected priority level from a plurality of priority levels.

18. The apparatus according to claim 17, wherein the list of priority phone numbers has a priority for each phone number that is provisioned by the terminal.

19. The apparatus according to claim 17, wherein the terminal is one of a wireless terminal and a wired terminal.

20. The apparatus according to claim 17, wherein the terminal is one of a cell phone, a personal data assistant, a laptop computer, a desktop computer, and a wireline phone.
